(19) United States
(12) Patent Application Publication
(10) Pub. No.: US 2012/0327375 A1
(43) Pub. Date: Dec. 27, 2012

(54) ILLUMINATION DEVICE AND PROJECTION DISPLAY DEVICE USING THE SAME

(76) Inventors: Mikio Sakamoto, Tokyo (JP); Jun Ogawa, Tokyo (JP); Akihiro Osaka, Tokyo (JP)

(21) Appl. No.: 13/583,142

(22) PCT Filed: Mar. 9, 2010
(86) PCT No.: PCT/JP2010/053893

§ 371 Date: Sep. 6, 2012

(51) Int. Cl. G03B 21/14; G02B 6/04

(52) U.S. Cl. 353/31; 362/554; 353/38

(57) ABSTRACT

An illumination device includes a light source that is configured to emit diffused light, and a plurality of light guiding bodies configured such that the light emitted by light source is entered from one end surface and the light is exited from other end surface. End surface of each light guiding body is arranged into a concave shape, and end surface is arranged into a planar shape.

### TECHNICAL FIELD

The present invention relates to an illumination device for a projection display device.

### BACKGROUND ART

Patent Literature 1 describes a projection display device that includes: a light source; a plurality of optical fibers, each optical fiber being configured such that light emitted by the light source is entered from one end surface and the light is exited from the other end surface; a display device illuminated with the light output from the other surface of the optical fibers; and a projection lens group for projecting an image formed by the display device. One end surface (incident side) of each optical fiber is formed into a planar shape.

### CITATION LIST

### Patent Literature

Patent Literature 1: PCT National Publication No. 2003-523531 (FIG. 3)

### SUMMARY OF INVENTION

Generally, in the projection display device that illuminates the display element with the light from the light source, and projects the image formed by the display element via a projection optical system, designing the arrangement of illumination devices needs to be based on restrictions imposed by etendue determined by the light exit sectional area of the light source and the divergence angle of the exit light. In other words, to utilize all the lights emitted from the light source as projection lights, a value of the product of the light exit sectional area of the light source and the divergence angle of the exit light must be set equal to or lower than a value of the product of the display area of the display element and a capture angle (solid angle) determined by the F number of the projection optical system. Unless this condition is satisfied, part of the light from the light source cannot be used as projection light.

When a light source that emits diffused lights is used, among the diffused lights emitted from the light source, only diffused light emitted at a divergence angle determined by the restrictions of the etendue is used as projection light, while the other lights are not used as projection lights. Light use efficiency accordingly drops.

In the projection display device described in Patent Literature 1, when the numerical aperture of the optical fiber is smaller than that of the projection lens group, the exit angle of the light flux output from the other end surface of each optical fiber is smaller than the divergence angle determined by the restrictions of the etendue. In this case, most of the light flux output from the other end surface of each optical fiber can be used as projection light.

However, since the end surface (incident surface) of each optical fiber is arranged into a planar shape, for example, when a light source that emits diffused lights in all directions is used, only some of the diffused lights enter the optical fiber while the others do not enter the optical fiber. The light that does not enter the optical fiber cannot be used as projection light, thus causing a reduction of light use efficiency.

It is therefore an object of the present invention to provide an illumination device that is capable of solving the aforementioned problem of the reduction of the use efficiency caused by the restrictions of the etendue and is thus high in light use efficiency, and a projection display device using the same.

To achieve the above object, an illumination device according to the present invention includes: a light source that emits diffused light; and a plurality of light guiding bodies, each light guiding body being configured such that the light emitted by the light source is entered from one end surface and the light is exited from the other end surface. The one end surfaces of the plurality of light guiding bodies are arranged into a concave shape, and the other end surfaces of the plurality of light guiding bodies are arranged into a planar shape.

According to an aspect of the present invention, a projection display device includes: the aforementioned illumination device; a display element illuminated with light from the illumination device; and a projection optical system that projects an image displayed by the display element.

According to another aspect of the present invention, a projection display device includes: a plurality of illumination devices each being the aforementioned illumination device and configured to emit lights of different colors; a plurality of display elements arranged corresponding to the plurality of illumination devices and illuminated with lights from the corresponding illumination devices; a prism unit configured such that the lights from the plurality of display elements are entered from different incident surfaces and the lights are exited from the same exit surface; and a projection optical system that projects image lights of respective colors from the plurality of display elements supplied via the prism unit.

According to yet another aspect of the present invention, a projection display device includes: a plurality of illumination devices each being the aforementioned illumination device and configured to emit lights of different colors; a prism unit configured such that the lights from the plurality of illumination devices are entered from different incident surfaces and the lights are exited from the same exit surface; a display element illuminated with the lights from the plurality of illumination devices via the prism unit; and a projection optical system that projects image lights of respective colors from the display element,

### BRIEF DESCRIPTION OF DRAWINGS

FIG. 1 is a schematic view showing the configuration of an illumination device according to the first exemplary embodiment of the present invention.

FIG. 2 is a schematic view showing the example of a light source using a phosphor.

FIG. 3 is an explanatory diagram showing a relationship between the radius and the surface area of a concave surface constituted by the end surface of each light guiding body in the illumination device shown in FIG. 1,

FIG. 4 is a schematic view showing the example of a gap generated more easily when the end surfaces of respective light guiding bodies are arranged adjacent to one another in the illumination device shown in FIG. 1.

FIG. 5 is a schematic view showing the configuration of an illumination device according to the second exemplary embodiment of the present invention.

FIG. 6A is a schematic view showing the arrangement example of a microlens in the illumination device shown in FIG. 5.

FIG. 6B is a schematic view showing a square-shaped microlens.

FIG. 7 is a schematic view showing a projection display device including the illumination device of the present invention according to a first exemplary embodiment.

FIG. 8 is a schematic view showing a projection display device including the illumination device of the present invention according to a second exemplary embodiment.

FIG. 9 is a schematic view showing a projection display device including the illumination device of the present invention according to a third exemplary embodiment.

### EXPLANATION OF REFERENCE NUMBERS

1 Light source
2 Light guiding body
2a, 2b End surface
3 Display element

### BEST MODE FOR CARRYING OUT THE INVENTION

Next, the embodiments of the present invention will be described with reference to the drawings.

### First Exemplary Embodiment

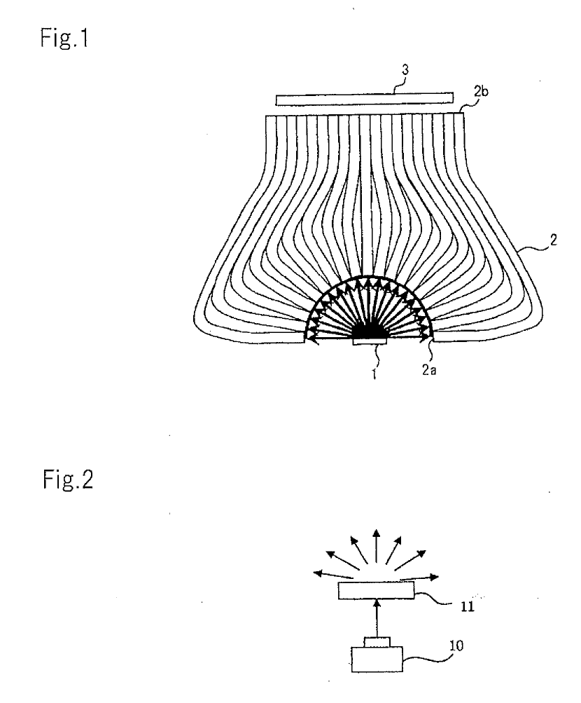

FIG. 1 is a schematic view showing the configuration of an illumination device according to the first exemplary embodiment of the present invention.

Referring to FIG. 1, the illumination device, which is used for a projection display device such as a projector, includes light source 1 that is configured to emit diffused light, and a plurality of light guiding bodies 2 that are configured that the light emitted by light source 1 is entered to one end surface 2a and the light is exited from other end surface 2b. End surface 2a of each light guiding body 2 is formed into a concave shape, and end surface 2b is formed into a planar shape. The arrangement of the concave shape includes not only a curved shape but also a folded shape.

Light source 1 is, for example, a semiconductor light source such as a light emitting diode

(LED) or a semiconductor laser (LD), a light source referred to as a solid light source, or a light source using a phosphor. As light source 1, a secondary light source provided by forming the image of a light source such as a mercury lamp via an optical system can be used.

FIG. 2 shows the example of a light source using a phosphor. The light source shown in FIG. 2 includes excitation light source 10, and phosphor 11 excited by excitation light from excitation light source 10 to emit fluorescence. The fluorescence emitted from phosphor 11 is diffused light.

Light guiding body 2 is, for example, an optical fiber. Material for the optical fiber is quartz, a synthetic resin (e.g., plastic), or a photonic crystal. An optical fiber circular or polygonal (e.g., hexagonal) in section can be used for light guiding body 2.

End surface 2a of each light guiding body 2 is located, for example, along a hemispherical surface around the light emitting center (center of gravity of a light emitting surface in the case of surface emission) of light source 1. In this case, end surfaces 2a of respective light guiding bodies 2 constitute a hemispherical concave surface. The ends (ends of end surfaces 2a) of respective light guiding bodies 2 are fixed to each other to maintain the arrangement of the hemispherical concave surface. Adhesives can be used to fix the ends of respective light guiding bodies 2 to each other.

Each end surface 2a of light guiding body 2 can be located so that a perpendicular line drawn from the center of gravity of the end surface (its center when the shape of the end surface has a center of a circle or the like) can pass through the light emitting center of light source 1. This arrangement enables efficient entry of the light from light source 1 into end surface 2a of each light guiding body 2.

End surface 2b of each light guiding body 2 is located, for example, along a plane. The other ends (ends of end surfaces 2b) of respective light guiding bodies 2 are fixed to each other to maintain the arrangement. Adhesives can be used to fix the other ends of respective light guiding bodies 2 to each other.

The plane constituted by end surface 2b of each light guiding body 2 is located to face the display surface of display element 3, and its shape is almost similar to that of the display surface. Display element 3 is a liquid crystal display element or a DMD (digital micromirror device) element. The shape of the display surface of the liquid crystal display element or the DMD element is square. Thus, when such an element is used as display element 3, the plane constituted by end surface 2b of each light guiding body 2 is formed into a square shape.

The area S1 of the plane constituted by end surface 2b of each light guiding body 2 is approximately equal to the display area S2 of display element 3. However, the area S1 is larger than the area 52. When there is a gap between the end surfaces, for convenience, the area of the gap is within the area S1.

The surface area of the concave surface constituted by end surface 2a of each light guiding body 2 is equal to the area S1 of the plane constituted by end surface 2b of each light guiding body 2. Accordingly, when end surface 2a of each light guiding body 2 constitutes a hemispherical concave surface, the lower limit of a value of the radius of the hemisphere (i.e., distance from the light emitting center to end surface 2a) is determined by the surface area S2 of display element 3.

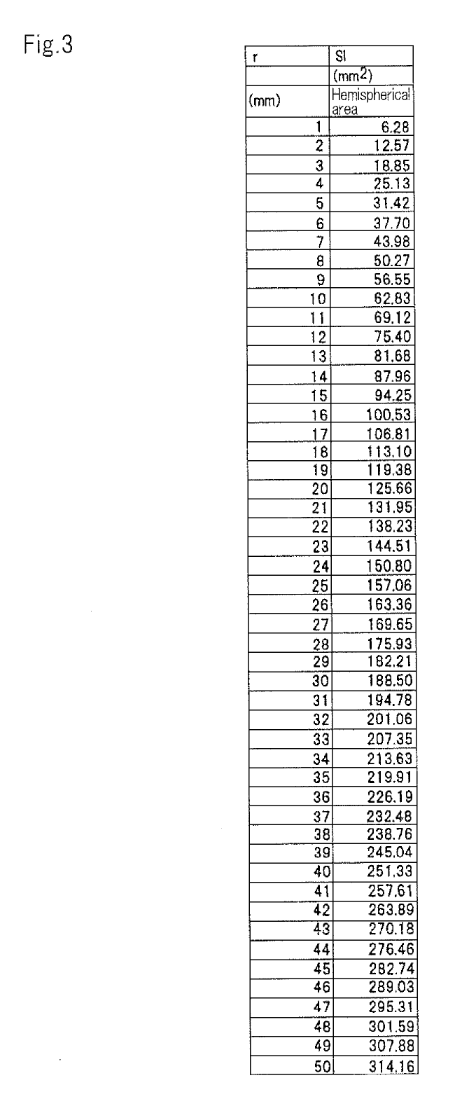

FIG. 3 shows a relationship between the radius and the surface area of the concave surface. This table shows a radius r (millimeter) and the surface area S1 (square meter) of the concave surface.

According to the illumination device of this embodiment, most of diffused light from light source 1 enters end surface 2a of each light guiding body 2. The light receiving angle θ of end surface 2a of light guiding body 2 is determined by the numerical aperture (NA) of light guiding body 2. A relationship between the light receiving angle θ and the NA is represented by NA =nsinθ, where n is a refractive index of a medium between one end surface of light guiding body 2 and light source 1. Normally, the medium is air, and its refractive index is approximately 1. Accordingly, the relationship between the light receiving angle θ and the NA is represented by NA=sinθ. The NA of the optical fiber used as light guiding body 2 is about 0.25 to 0.63. The NA of the quartz fiber is 0.30 to 0.35, and the NA of the plastic fiber is 0.32 to 0.63.

When N light guiding bodies 2 are used, the solid angle Ω of the diffused light from light source 1 with respect to one light guiding body 2 is represented by Ω/N. In this case, the maximum incident angle of the diffused light of the solid angle Ω/N with respect to end surface 2a of each light guiding body 2 is equal to or smaller than the light receiving angle θ.

The exit angle of the light output from end surface 2b of light guiding body 2 is equal to the light receiving angle θ. The light entered from end surface 2a of light guiding body 2 is propagated through light guiding body 2 while being fully reflected to exit from end surface 2b. The exit angle of the diffused light output from end surface 2b of light guiding body 2 is equal to the solid angle Ω/N (exit angle of the diffused light is equal to or smaller than θ).

Most of the diffused light of solid angles Ω emitted from light source 1 passes through the plurality of light guiding bodies 1 A plurality of diffused lights having solid angles Ω/N exit from the plane constituted by end surface 2b of each light guiding body 2 in a direction vertical to the plane. The spread angle of the entire light flux including the diffused lights is almost equal to the solid angle Ω/N.

Thus, according to the illumination device of this embodiment, since end surface 2a (incident side) of each light guiding body 2 is formed into the concave shape, most of the diffused light emitted from light source 1 can enter end surface 2b of each light guiding body 2. The diffused light emitted from light source 1 passes through each light guiding body 2 to be converted into a light flux including a plurality of diffused lights having solid angles equal to or smaller than a divergence angle determined by the restrictions of etendue. As a result, when the display surface of display element 3 is irradiated with diffused light output from the plane constituted by end surface 2b of each light guiding body 2, and an image formed on the display surface is projected by the projection optical system, most of the diffused light emitted from light source 1 can be used as projection light.

The liquid crystal display element has characteristics of incident angle dependence of transmittance (or reflectance). Thus, when the liquid crystal element is used as display element 3, an incident angle to display element 3 is limited within an angle range determined by the incident angle dependency. According to the illumination device of this embodiment, the exit angle of the diffused light output from the plane constituted by end surface 2b of each light guiding body 2 can be set within the angle range determined by the incident angle dependence of the liquid crystal display element.

In this embodiment, when a circular cross-section optical fiber is used for light emitting body 2, a gap is generated between adjacent end surfaces 2a. FIG. 4 shows the example of a gap.

FIG. 4 shows four circular cross-section optical fibers which are adjacently arranged when seen from a direction vertical to the end surface. In this example, gap 2c (shaped part) is generated among four end surfaces 2a. Light that has entered gap 2c cannot be used, and light loss consequently occurs.

By using a hexagonal cross-section optical fiber, end surfaces can be arranged without any gap. Thus, the light loss caused by the gap can be suppressed.

### Second Exemplary Embodiment

An optical fiber includes a core for propagating light, and a clad formed on the outer circumference of the core. When light enters the entire end surface of the optical fiber, the light that entered the clad portion cannot be used, and light loss consequently occurs. A structure that is capable of suppressing the light loss caused by the clad will be described.

FIG. 5 is a schematic view showing the configuration of an illumination device according to the second exemplary embodiment of the present invention.

The illumination device of this embodiment is similar to that of the first embodiment except for the inclusion of microlens array 4. In FIG. 5, components similar to those of the first embodiment are denoted by similar reference numerals.

Microlens array 4 includes a plurality of microlenses provided for each light guiding body 2. Microlens array 4, which is formed into a concave shape, is located to face a concave surface constituted by end surface 2a of each light guiding body 2. The interval between microlens array 4 and the concave surface constituted by end surface 2a of each light guiding body 2 is roughly constant.

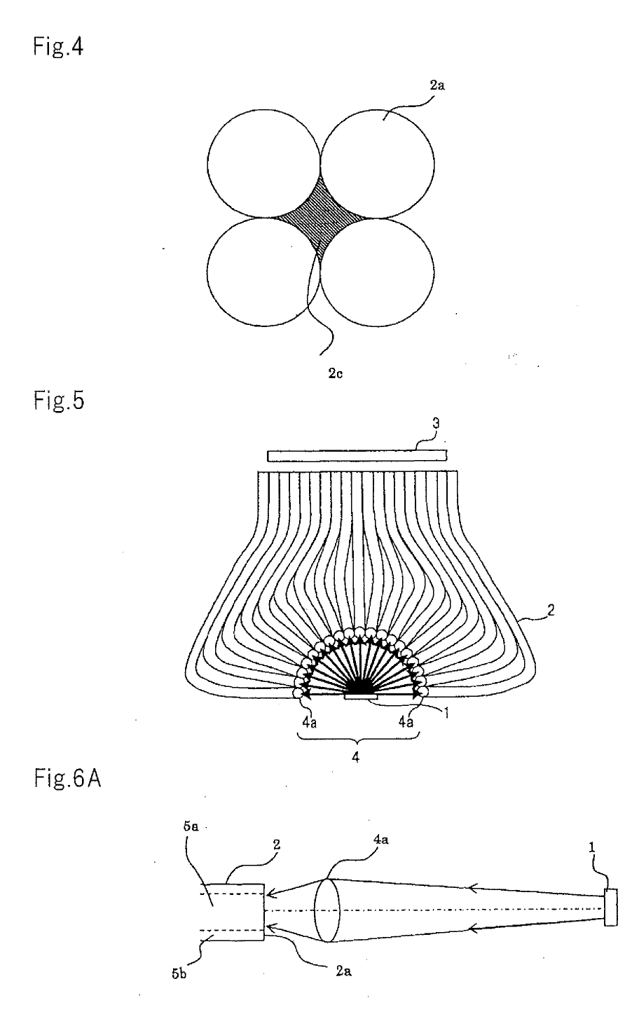

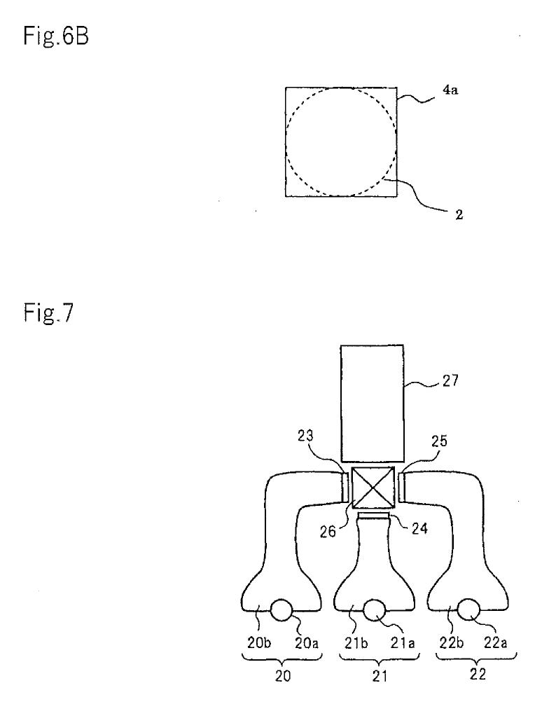

FIG. 6A shows the arrangement example of the microlenses. Microlens 4a is disposed between corresponding end surface 2a of light guiding body 2 and light source 1, and diffused light from light source 1 is condensed in the area of core 5a of end surface 2a.

For example, when N light guiding bodies 2 are used, among diffused lights of solid angles Ω emitted from light source 1, diffused light having a solid angle Ω/N is condensed in the area of core 5a of corresponding end surface 2a of light guiding body 2.

In the first embodiment, a part of the diffused light of the solid angle Ω/N may enter the area of clad 5b of end surface 2a to cause light loss. On the other hand, in this embodiment, most of the diffused light of the solid angle Ω/N enters the area of core 5a of end surface 2a via microlens 4a, causing no light loss at clad 5b. Accordingly, light use efficiency can be improved.

Microlens 4 is not limited to the circular shape when seen from the direction vertical to end surface 2a of light guiding body 2. The shape of microlens 4a can be changed depending on the sectional shapes of the light guiding bodies or the arrangement of the end surfaces of the light guiding bodies as occasion demands.

FIG. 6B is a schematic view showing a square microlens. Microlens 4a, which is formed into a conical shape, is square when seen from the direction vertical to end surface 2a of light guiding body 2. Microlens array 4 including such microlenses 4a is disposed to face the concave surface constituted by end surface 2a of light guiding body 2. In this case, not only light loss caused by the clad portion but also light loss caused by the gap among the end surfaces can be suppressed.

The illumination device of each of the foregoing embodiments is only an example, and its constitution can be changed as occasion demands without departing from the spirit and the scope of the present invention.

For example, in the illumination device of each embodiment, some of the diffused lights output from end surfaces 2a of light guiding bodies 2 overlap one another, causing uneven luminance of the light flux output from the entire plane constituted by end surfaces 2b of light guiding bodies 2. To reduce the uneven luminance, a light diffusion plate (or light diffusion layer) can be disposed on the plane constituted by end surfaces 2b of light guiding bodies 2 or in a position opposite the plane.

The concave surface constituted by end surface 2a of each light guiding body 2 is not limited to the hemispherical shape. End surface 2a of each light guiding body 2 can constitute a partially elliptic surface or a folded surface. For example, supposing that the light emitting center of light source 1 is located in the gravitational center position of one surface of a rectangular parallelepiped, end surface 2a of each light guiding body 2 can be disposed along the other surface of the rectangular parallelepiped, and ends of light guiding bodies 2 may be fixed to each other in the disposition.

In each of the foregoing embodiments, end surfaces 2b may randomly be arranged irrespective of the arranging order of end surfaces 2a. When the light emitted from light source 1 has a luminance distribution, end surfaces 2b of light guiding bodies 2 that are arranged in an area where luminance of end surfaces 2a is high may be arranged almost uniformly on the entire plane. End surfaces 2b of light guiding bodies 2 arranged in an area where luminance of end surfaces 2a is low may be arranged almost uniformly on the entire plane.

The illumination device of the present invention can be applied to a general projection display device. The illumination device of the present invention can emit light having a small spread angle, and thus it can be applied to a display device such as a liquid crystal display device. In particular, by applying the present invention to the liquid crystal display device, light loss that is caused by the incident angle dependency of the liquid crystal display element can be suppressed.

Hereinafter, a projection display device including the illumination device of the present invention will be described.

### Projection Display Device of First Exemplary Embodiment

FIG. 7 is a schematic view showing a projection display device including the illumination device of the present invention according to a first exemplary embodiment.

Referring to FIG. 7, the projection display device includes illumination devices 20 to 22, display elements 23 to 25, cross dichroic mirror 26, and projection optical system 27.

Illumination device 20 includes red light source 20a and a plurality of light guiding bodies 20b. Illumination device 21 includes green light source 21a and a plurality of light guiding bodies 21b. Illumination device 22 includes blue light source 22a and a plurality of light guiding bodies 22b. Each of illumination devices 20 to 22 is similar in configuration to any one of the illumination devices of the first embodiment and the second embodiment.

Display element 23 is disposed in a position facing the exit surface of illumination device 20. Display element 24 is disposed in a position facing the exit surface of illumination device 21. Display element 25 is disposed in a position facing the exit surface of illumination device 22. Display elements 23 to 25 are transmissive display elements, for example, liquid crystal display elements. When the liquid crystal elements are used for display elements 23 to 25, polarization conversion means for aligning polarizing directions are arranged between display element 23 and illumination device 20, between display element 24 and illumination device 21, and between display element 25 and illumination device 22.

Red light emitted from illumination device 20 is applied to display element 23. Display element 23 is driven by a driving circuit (not shown) to form an image for a red color based on a video signal supplied from the outside.

Green light emitted from illumination device 21 is applied to display element 24. Display element 24 is driven by a driving circuit (not shown) to form an image for a green color based on a video signal supplied from the outside.

Blue light emitted from illumination device 22 is applied to display element 25. Display element 25 is driven by a driving circuit (not shown) to form an image for a blue color based on a video signal supplied from the outside.

Cross dichroic mirror 26, which has a prism structure in which lights from display elements 23 to 25 are entered from different incident surfaces and the lights are exited from the same exit surface, includes a first dichroic mirror for transmitting green and blue wavelengths while reflecting a red wavelength, and a second dichroic mirror that is disposed to intersect the first dichroic mirror and that is configured to transmit the red and green wavelengths while reflecting the blue wavelength.

The image lights of respective colors formed by display elements 23 to 25 enter projection optical system 27 via cross dichroic mirror 26. Projection optical system 27 projects the images of respective colors formed by display elements 23 to 25 onto a screen (not shown, or member in place of the screen).

According to this projection display device, since most of diffused lights emitted from light sources 20a, 21a, and 22a of illumination devices 20 to 22 can be used as projection lights, light use efficiency can be improved, and bright projected images can be acquired.

In illumination device 20, the diffused light from red light source 20a is guided to display element 23 by flexible light guiding body 20b. Similarly, in illumination device 21, the diffused light from green light source 21a is guided to display element 24 by flexible light guiding body 21b. In illumination device 22, the diffused light from blue light source 22a is guided to display element 25 by flexible light guiding body 22b. This configuration of guiding the diffused lights by flexible light guiding bodies 20b, 21b, and 22b enables free arrangement of light guiding bodies 20b, 21b, and 22b, and thus the freedom in designing the arrangement of illumination devices can be improved.

### Projection Display Device of Second Exemplary Embodiment

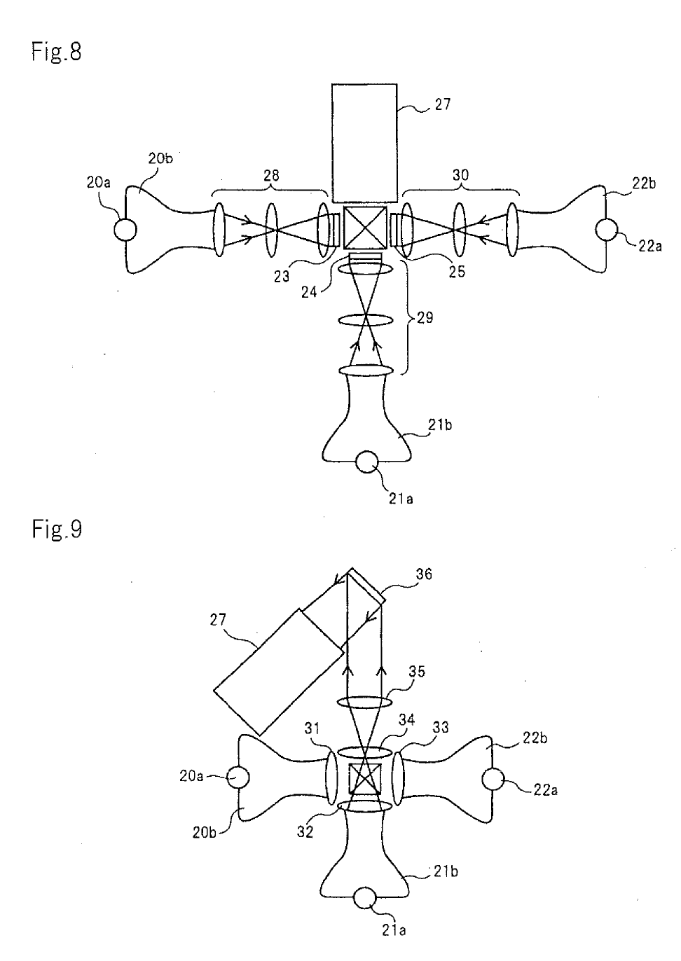

FIG. 8 is a schematic view showing a projection display device including the illumination device of the present invention according to a second exemplary embodiment.

The projection display device of this embodiment is similar to that of the first embodiment except for inclusion of relay lenses 28 to 30.

Each of relay lenses 28 to 30 includes a second lens located in the center and first and third lenses located on both sides of the second lens. A magnification of the relay lens is determined by the ratio of the interval between the first lens and the second lens to the interval between the second lens and the third lens.

Relay lens 28, which is located between illumination device 20 and display element 23, applies a light source image formed on the exit surface of illumination device 20 to the display surface of display element 23. The display area of display element 20 and the area of the exit surface (plane constituted by end surface 2b of each light guiding body 2 shown in FIG. 1) of illumination device 20 are determined according to the magnification of relay lens 28. In other words, the magnification of relay lens 28 is determined according to the ratio of the display area of display element 23 to the area of the exit surface of illumination device 20.

Relay lens 29, which is located between illumination device 21 and display element 24, applies a light source image formed on the exit surface of illumination device 21 to the display surface of display element 24. The magnification of relay lens 29 is determined according to the ratio of the display area of display element 24 to the area of the exit surface of illumination device 21.

Relay lens 30, which is located between illumination device 22 and display element 25, applies a light source image formed on the exit surface of illumination device 22 to the display surface of display element 25. The magnification of relay lens 30 is determined according to the ratio of the display area of display element 25 to the area of the exit surface of illumination device 22.

According to this projection display device, in addition to the effects provided by the projection display device of the first embodiment, by arranging relay lenses 28 to 30 between illumination devices 20 to 22 and display elements 23 to 25, an effect in which design freedom improves the relationship between the areas of the exit surfaces of illumination devices 20 to 22 and the display areas of display elements 23 to 25 can be provided.

Each of relay lenses 28 to 30 can include one lens.

### Projection Display Device of Third Exemplary Embodiment

FIG. 9 is a schematic view showing a projection display device including the illumination device of the present invention according to a third exemplary embodiment.

Referring to FIG. 9, the projection display device includes illumination devices 20 to 22, lenses 31 to 35, cross dichroic mirror 26, reflective display element 36, and projection optical system 37. Illumination devices 20 to 22 and cross dichroic mirror 26 are similar in configuration to those of the projection display device of the first embodiment.

Lens 31 is disposed between the exit surface of illumination device 20 and the first incident surface of cross dichroic mirror 26. Lens 32 is disposed between the exit surface of illumination device 21 and the second incident surface of cross dichroic mirror 26. Lens 33 is disposed between the exit surface of illumination device 22 and the third incident surface of cross dichroic mirror 26.

Lenses 34 and 35 and reflective display element 36 are located in the traveling direction of light emitted from the exit surface of cross dichroic mirror 26.

Reflective display element 36, which is a reflective liquid crystal display element or a DMD element, displays red, green, and blue images based on video signals from the outside in time division. In synchronization with the time-division displaying, emission timings of red light source 20a, green light source 21a, and blue light source 22a are controlled. Projection display device 37 projects the images of respective colors displayed in time division by reflective display element 36 onto a screen (not shown, or member in place of the screen).

Red light emitted from illumination device 20 is applied to reflective display element 36 via lens 31, cross dichroic mirror 26, and lenses 34 and 35. On the optical path of the red light, lenses 31, 34, and 35 operate as relay lenses.

Green light emitted from illumination device 21 is applied to reflective display element 36 via lens 32, cross dichroic mirror 26, and lenses 34 and 35. On the optical path of the green light, lenses 32, 34, and 35 operate as relay lenses.

Blue light emitted from illumination device 22 is applied to reflective display element 36 via lens 33, cross dichroic mirror 26, and lenses 34 and 35. On the optical path of the blue light, lenses 33, 34, and 35 operate as relay lenses.

This projection display device provides the same operation effects as those of the projection display devices of the first and second embodiments.

In this projection display device, lenses 31 to 35 can be removed.

In the projection display device according to each of the embodiments, the NA of the projection optical system can be matched with that of the light guiding body (e.g., optical fiber) of the illumination device. Normally, when a projection optical system is designed by taking into consideration the restrictions of etendue and the solid angle of the diffused light of a light source, the NA of the projection optical system is set large. According to the present invention, the NA of the projection optical system only needs to be equal to or larger than that of the light guiding body. The NA of the projection optical system can accordingly be reduced. Compared with an optical system having a large NA, designing an optical system having a small NA is easier. Thus, matching the NA of the projection optical system with that of the light guiding body facilitates designing of the projection optical system.

The projection display device according to each of the embodiments is a configuration example to which the illumination device of the present invention is applied. The configuration can be changed as occasion demands. For example, the projection display device includes at least one illumination device, a display element irradiated with light from the illumination device, and a projection optical system for projecting an image displayed by the display element. When the number of illumination devices is one, an image of a single color is projected. When there is a plurality of illumination devices, lights from the illumination devices are color-synthesized by using a cross dichroic mirror. By irradiating the display element with the color-synthesized image, an image including a plurality of colors can be projected. In this case, relay lenses can be arranged between the illumination devices and the display element.

1. An illumination device comprising:
a light source that emits diffused light; and
a plurality of light guiding bodies, each light guiding body being configured such that the light emitted by the light source is entered from one end surface and the light is exited from the other end surface,
wherein the one end surfaces of the plurality of light guiding bodies are arranged into a concave shape, and the other end surfaces of the plurality of light guiding bodies are arranged into a planar shape.

2. The illumination device according to claim 1, wherein the one end surfaces of the plurality of light guiding bodies are arranged into a hemispherical shape around a light emitting center of the light source.

3. The illumination device according to claim 1, wherein each one end surface of the plurality of light guiding bodies is disposed so that a perpendicular line drawn from a center of gravity of the end surface can pass through the light emitting center of the light source.

4. The illumination device according to claim 1, further comprising a plurality of microlenses each disposed in positions facing the one end surfaces of the plurality of light guiding bodies,
wherein each of the plurality of microlenses condenses the diffused light emitted from the light source in a predetermined area of the opposite one end surface.

5. The illumination device according to claim 1, further comprising light diffusion means disposed in a position facing the other end surfaces of the plurality of light guiding bodies.

6. The illumination device according to claim 1, wherein the plurality of light guiding bodies comprises an optical fiber.

7. The illumination device according to claim 1, wherein the light source includes an excitation light source and a phosphor excited by excitation light from the light source to output fluorescence.

8. A projection display device comprising:
the illumination device according to claim 1;
a display element illuminated with light from the illumination device; and
a projection optical system that projects an image displayed by the display element.

9. A projection display device comprising:
a plurality of illumination devices, each device being the illumination device according to claim 1 and being configured to emit lights of different colors;
a plurality of display elements arranged corresponding to the plurality of illumination devices and illuminated with lights from the corresponding illumination devices;
a prism unit configured such that the lights from the plurality of display elements are entered from different incident surfaces and the lights are exited from the same exit surface; and
a projection optical system that projects image lights of respective colors from the plurality of display elements supplied via the prism unit.

10. The projection display device according to claim 9, further comprising a plurality of relay lenses arranged between the exit surfaces of the plurality of illumination devices and the incident surfaces of the prism unit.

11. A projection display device comprising:
a plurality of illumination devices, each device being the illumination device according to claim 1 and being configured to emit lights of different colors;
a prism unit configured such that the lights from the plurality of illumination devices are entered from different incident surfaces and the lights are exited from the same exit surface;
a display element illuminated with the lights from the plurality of illumination devices via the prism unit; and
a projection optical system that projects image lights of respective colors from the display element.

12. The projection display device according to claim 11, further comprising:
first to third lenses arranged between the exit surfaces of the plurality of illumination devices and the incident surfaces of the prism unit; and
fourth and fifth lenses arranged between the exit surface of the prism unit and the display element,
wherein each of the first to third lenses and the fourth and fifth lenses constitute relay lenses.

13. The illumination device according to claim 2, wherein each one end surface of the plurality of light guiding bodies is disposed so that a perpendicular line drawn from a center of gravity of the end surface can pass through the light emitting center of the light source.

14. The illumination device according claim 2, further comprising a plurality of microlenses each disposed in positions facing the one end surfaces of the plurality of light guiding bodies,
wherein each of the plurality of microlenses condenses the diffused light emitted from the light source in a predetermined area of the opposite one end surface.

15. The illumination device according to claim 3, further comprising a plurality of microlenses each disposed in positions facing the one end surfaces of the plurality of light guiding bodies,
wherein each of the plurality of microlenses condenses the diffused light emitted from the light source in a predetermined area of the opposite one end surface.

16. The illumination device according to claim 2, further comprising light diffusion means disposed in a position facing the other end surfaces of the plurality of light guiding bodies.

17. The illumination device according to claim 3, further comprising light diffusion means disposed in a position facing the other end surfaces of the plurality of light guiding bodies.

18. The illumination device according to claim 4, further comprising light diffusion means disposed in a position facing the other end surfaces of the plurality of light guiding bodies.

19. The illumination device according to claim 2, wherein the plurality of light guiding bodies comprises an optical fiber.

20. The illumination device according to claim 3, wherein the plurality of light guiding bodies comprises an optical fiber.
